(19) United States
(12) Patent Application Publication
(10) Pub. No.: US 2015/0294420 A1
(43) Pub. Date: Oct. 15, 2015

(54) SYSTEMS, METHODS, AND COMPUTER PROGRAM PRODUCTS THAT FACILITATE LIFE INSURANCE UNDERWRITING WITH INCOMPLETE DATA

(71) Applicant: BioSignia, Inc., Cary, NC (US)

(72) Inventor: Guizhou Hu, Cary, NC (US)

(73) Assignee: BioSignia, Inc., Cary, NC (US)

(21) Appl. No.: 14/252,203

(22) Filed: Apr. 14, 2014

(51) Int. Cl. G06Q 40/08

(52) U.S. Cl. CPC G06Q 40/08

(57) ABSTRACT

Methods, systems and computer program products for generating a decision to underwrite a life insurance policy for an applicant are provided. Information about the applicant is obtained, an individual mortality ratio value for the applicant is generated using the applicant information, the mortality ratio value is applied to a population mortality value to generate a mortality risk value for the applicant, and an underwriting decision regarding the applicant is generated based on the applicant's mortality risk value. Applicant information includes a plurality of data elements, each data element is associated with a characteristic of the applicant. Generating the individual mortality ratio value for the applicant includes generating a deviation of each data element from a respective mean value, obtaining a mortality relative risk estimate for each respective data element, and generating the individual mortality ratio value (MR) via: MR=exp (ln(RR₁)(x₁−x₁ₘ)+ln(RR₂)(x₂−x₂ₘ) . . . ln(RRₙ−xₙₘ)).

### FIELD OF THE INVENTION

The present application relates generally to insurance underwriting and, more particularly, to insurance underwriting systems, methods, and computer program products.

### BACKGROUND

Underwriting is the process used by an insurance company to determine whether or not a potential applicant for insurance, such as life insurance, is eligible, and the rate that potential applicant should pay for the insurance if eligible. Underwriting enables an insurance company to reject certain applicants and to charge other applicants premiums that are commensurate with the level of risk. Often regarded as a combination of science and art, the process of life insurance underwriting conventionally involves a trained underwriter making underwriting decisions based on (1) data collected from applicants, (2) company-specific underwriting guidelines, and (3) the underwriter's own knowledge and opinions.

Recently, new developments in life insurance underwriting have included the introduction of predictive analytics technology, thereby providing the ability to leverage internal and/or external data to evaluate, compute, and manage risk. Using predictive analytics and datasets ranging from clinical laboratory results and pharmacy benefit management programs to non-medical data found in the public domain (e.g., consumer, financial, and household data), life insurance companies are seeking a more efficient means of underwriting while maximizing savings and increasing underwriting volume. For example, U.S. Pat. No. 7,831,451 to Morse et al. describes systems and methods that integrate information from multiple online databases and create decision making advice useful to insurance underwriters.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the invention.

Embodiments of the present invention facilitate the determination of individual mortality risk scores to assist in life insurance underwriting decisions. Embodiments of the present invention can facilitate decision making even when underwriting data is incomplete.

According to some embodiments of the present invention, a method of generating a decision to underwrite a life insurance policy for an applicant includes obtaining information about the applicant, generating an individual mortality ratio value for the applicant using the applicant information, applying the mortality ratio value to a population mortality value to generate a mortality risk value for the applicant, and generating an underwriting decision regarding the applicant based on the applicant's mortality risk value. The applicant information includes a plurality of data elements, wherein each data element is associated with a characteristic of the applicant. Obtaining information about the applicant includes one or more of the following: a driving history report/motor vehicle record (MVR) of the applicant acquired from the state-level Department of Motor Vehicles (DMV), a prescription drug history through the pharmacy benefit management (PBM) program, the applicant's height, weight, date of birth, gender, smoking history, lifestyle history (alcohol and drug use, hazardous hobbies, such as auto racing, scuba diving, etc.), foreign travel plans and history of travel, occupation, history of insurance application(s) and result(s), family health history (disease and death), and the applicant's health history (disease diagnoses, medical procedures, and treatments). Additional options available for submission include: the applicant's blood pressure at the paramedical examination, blood and urine samples for complete insurance profile tests, and attending physicians statements (APS).

In some embodiments, obtaining information about the applicant includes excluding the applicant from further assessment if any data elements have a value that is beyond a pre-determined threshold value.

In some embodiments, obtaining the information from the applicant includes obtaining the plurality of data elements via a user interface displayed on a device.

In some embodiments, generating the individual mortality ratio value for the applicant includes generating a deviation of each data element from a respective mean value, expressed as x₁−x₁ₘ, x₂−x₂ₘ, . . . xₙ−xₙₘ, obtaining a mortality relative risk estimate for each respective data element, expressed as RR₁, RR₂, . . . RRₙ, and generating the individual mortality ratio value (MR) for the applicant via the following equation:

MR=exp (ln(RR₁)(x₁−x₁ₘ)+ln(RR₂)(x₂−x₂ₘ) . . . ln(RRₙ)(xₙ−xₙₘ)).

The mean value for each data element is applicant age, gender, and smoking-status specific. In addition, the population mortality value is for a hypothetical person having the same age, gender, and smoking status as the applicant.

According to some embodiments of the present invention, a system for generating a decision to underwrite a life insurance policy for an applicant includes a processor, and a memory that stores instructions that, when executed by the processor, cause the processor to perform operations including obtaining information about the applicant, generating an individual mortality ratio value for the applicant using the plurality of data elements, applying the mortality ratio value to a population mortality value to generate a mortality risk value for the applicant, and generating an underwriting decision regarding the applicant based on the applicant's mortality risk value. The applicant information includes a plurality of data elements, wherein each data element is associated with a characteristic of the applicant. Obtaining information about the applicant includes one or more of the following: a driving history report (MVR) of the applicant acquired from the state-level DMV, a prescription drug history through the PBM program, the applicant's height, weight, date of birth, gender, smoking history, lifestyle history (alcohol and drug use, hazardous hobbies, such as auto racing, scuba diving, etc.), foreign travel plans and history of travel, occupation, history of insurance application(s) and result(s), family health history (disease and death), applicant's health history (disease diagnoses, medical procedures, and treatments). Additional options available for submission include: the applicant's blood pressure at the paramedical examination, blood and urine samples for complete insurance profile tests, and APS.

In some embodiments, the memory stores instructions that, when executed by the processor, cause the processor to exclude the applicant from further assessment if any data elements have a value that is beyond a pre-determined threshold value.

In some embodiments, the memory stores instructions that, when executed by the processor, cause the processor to obtain the plurality of data elements via a user interface displayed on a device.

In some embodiments, the memory stores instructions that, when executed by the processor, cause the processor to generate the individual mortality ratio value for the applicant by generating a deviation of each data element from a respective mean value, expressed as x₁−x₁ₘ, x₂−x₂ₘ, . . . xₙ−xₙₘ, obtaining a mortality relative risk estimate for each respective data element, expressed as RR₁, RR₂, . . . RRₙ, and generating the individual mortality ratio value (MR) for the applicant via the following equation:

MR=exp (ln(RR₁)(x₁−x₁ₘ)+ln(RR₂)(x₂−x₂ₘ) . . . ln(RRₙ)(xₙ−xₙₘ)).

The mean value for each data element is applicant age, gender, and smoking-status specific. In addition, the population mortality value is for a hypothetical person having the same age, gender, and smoking status as the applicant.

According to some embodiments of the present invention, a computer program product includes a non-transitory computer readable storage medium having encoded thereon instructions that, when executed by a processor, cause the processor to perform operations including obtaining information about the applicant, generating an individual mortality ratio value for the applicant using the plurality of data elements, applying the mortality ratio value to a population mortality value to generate a mortality risk value for the applicant, and generating an underwriting decision regarding the applicant based on the applicant's mortality risk value. The applicant information includes a plurality of data elements, wherein each data element is associated with a characteristic of the applicant. Obtaining information about the applicant includes one or more of the following: a driving history report (MVR) of the applicant acquired from the state-level DMV, a prescription drug history through the PBM program, the applicant's height, weight, date of birth, gender, smoking history, lifestyle history (alcohol and drug use, hazardous hobbies, such as auto racing, scuba diving, etc.), foreign travel plans and history of travel, occupation, history of insurance application(s) and result(s), family health history (disease and death), applicant's health history (disease diagnoses, medical procedures, and treatments). Additional options available for submission include: the applicant's blood pressure at the paramedical examination, blood and urine samples for complete insurance profile tests, and APS.

In some embodiments, the computer readable storage medium has encoded thereon instructions that, when executed by a processor, cause the processor to exclude the applicant from further assessment if any data elements have a value that is beyond a pre-determined threshold value.

In some embodiments, the computer readable storage medium has encoded thereon instructions that, when executed by a processor, cause the processor to obtain the plurality of data elements via a user interface displayed on a device.

In some embodiments, the computer readable storage medium has encoded thereon instructions that, when executed by a processor, cause the processor to generate the individual mortality ratio value for the applicant by generating a deviation of each data element from a respective mean value, expressed as x₁−x₁ₘ, x₂−x₂ₘ, . . . xₙ−xₙₘ, obtaining a mortality relative risk estimate for each respective data element, expressed as RR₁, RR₂, . . . RRₙ, and generating the individual mortality ratio value (MR) for the applicant via the following equation:

MR=exp (ln(RR₁)(x₁−x₁ₘ)+ln(RR₂)(x₂−x₂ₘ) ln(RR₁)(xₙ−xₙₘ)).

The mean value for each data element is applicant age, gender, and smoking-status specific. In addition, the population mortality value is for a hypothetical person having the same age, gender, and smoking status as the applicant.

It is noted that aspects of the invention described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail below.

### BRIEF DESCRIPTION OF THE DRAWINGS

The accompanying drawings, which form a part of the specification, illustrate key embodiments of the present invention. The drawings and description together serve to fully explain the invention.

FIG. 1 is a flowchart illustrating operations for facilitating insurance underwriting with incomplete data, according to some embodiments of the present invention.

FIGS. 2A-2C illustrate an exemplary user interface for obtaining information about a person applying for life insurance, according to some embodiments of the present invention.

FIGS. 3A-3C illustrate an exemplary report of the assessment results and applicant information obtained via the user interface of FIGS. 2A-2C, according to some embodiments of the present invention.

FIGS. 4A-4B illustrate the classification thresholds of various applicants for life insurance from one example insurance company, according to some embodiments of the present invention.

FIG. 5 is a block diagram that illustrates details of an exemplary processor and memory that may be used for facilitating insurance underwriting with incomplete data, according to some embodiments of the present invention.

### DETAILED DESCRIPTION

The present invention will now be described more fully hereinafter with reference to the accompanying figures, in which embodiments of the invention are shown. This invention may, however, be embodied in many different forms and should not be construed as limited to the embodiments set forth herein. Like numbers refer to like elements throughout. In the figures, certain components or features may be exaggerated for clarity, and broken lines may illustrate optional features or elements unless specified otherwise. In addition, the sequence of operations (or steps) is not limited to the order presented in the figures and/or claims unless specifically indicated otherwise. Features described with respect to one figure or embodiment can be associated with another embodiment or figure although not specifically described or shown as such.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The term “about”, as used herein with respect to a value or number, means that the value or number can vary by +/−20%, 10%, 5%, 1%, 0.5%, or even 0.1%.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable, medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of the present invention may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

As used herein, a “risk factor” is any variable associated with a health outcome or state, such as a risk of disease, infection and/or health-related event, such as a stroke, diabetes, heart attack, cancer and death. Risk factors may be correlated with a health outcome or state and may or may not have a causal relationship with a health outcome or state.

According to some embodiments, systems, methods and computer program products are provided for facilitating insurance underwriting with incomplete data.

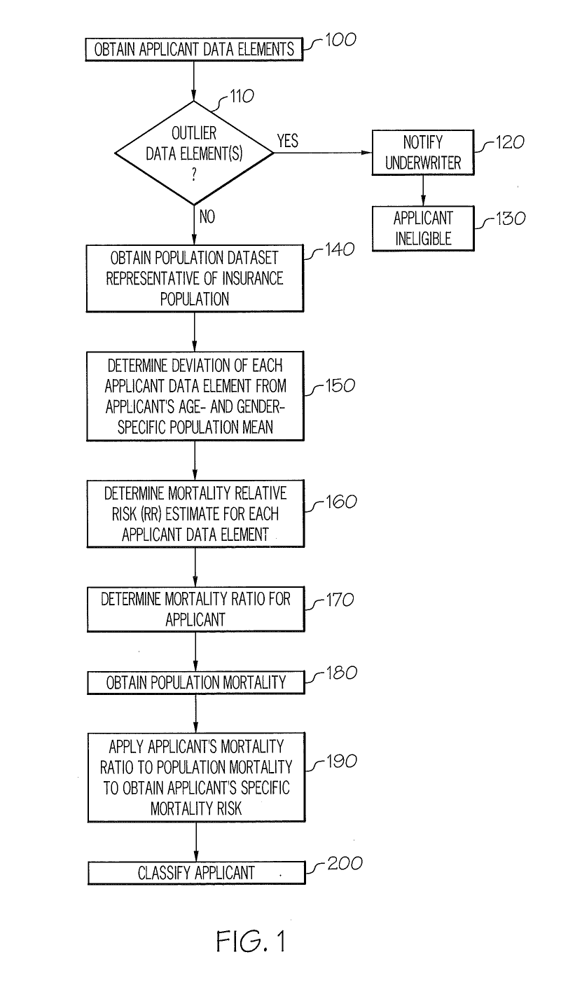

FIG. 1 is a flow chart of operations for facilitating life insurance underwriting with incomplete applicant data, according to some embodiments of the present invention. Initially, in addition to age and gender, various data elements are obtained from a person (referred to as an “applicant”), applying for life insurance (Block 100). These data elements include, but are not limited to, body mass index (BMI), family history of heart disease or cancer, blood pressure, height and weight, clinical laboratory results, etc. Data elements are expressed as x₁, x₂, . . . xₙ, and each data element can be coded as dichotomous (1=yes, 0=no), categorical, or continuous value (such as blood pressure).

These data elements may be obtained in various ways, such as from a life insurance application, a paramedical exam, and/or an underwriting process. For example, during the application process, an applicant typically discloses information such as, date of birth (age), gender, smoking history, disease history, lifestyle factors such as sports/hobbies, foreign travel, occupation, and self-reported height and weight. During a paramedical exam, the paramedical staff typically measures the applicant's height, weight, blood pressure, and typically collects blood and urine for lab tests. In addition, the insurer may obtain, for example, an attending physician statement (APS) from the applicant's attending physician, a copy of the applicant's driving record (MVR) from a motor vehicle department, a prescription history from a pharmacy benefit management company, and/or information from the Medical Insurance Bureau (MIB). The MIB maintains centralized files on the physical condition of individuals who have applied for life insurance with member companies.

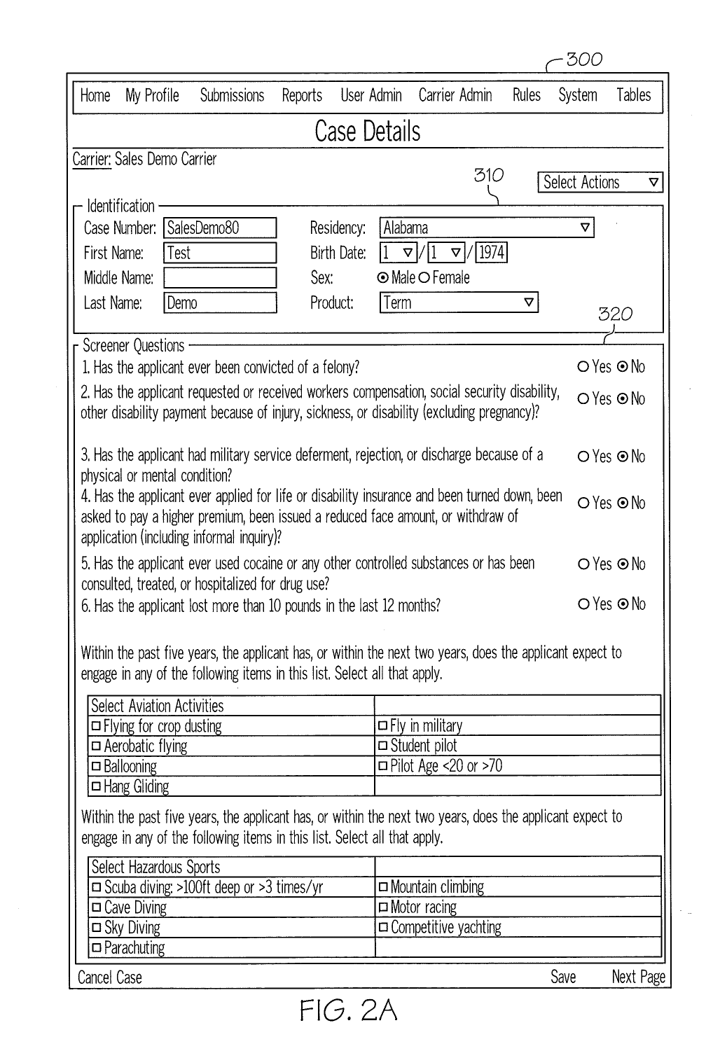

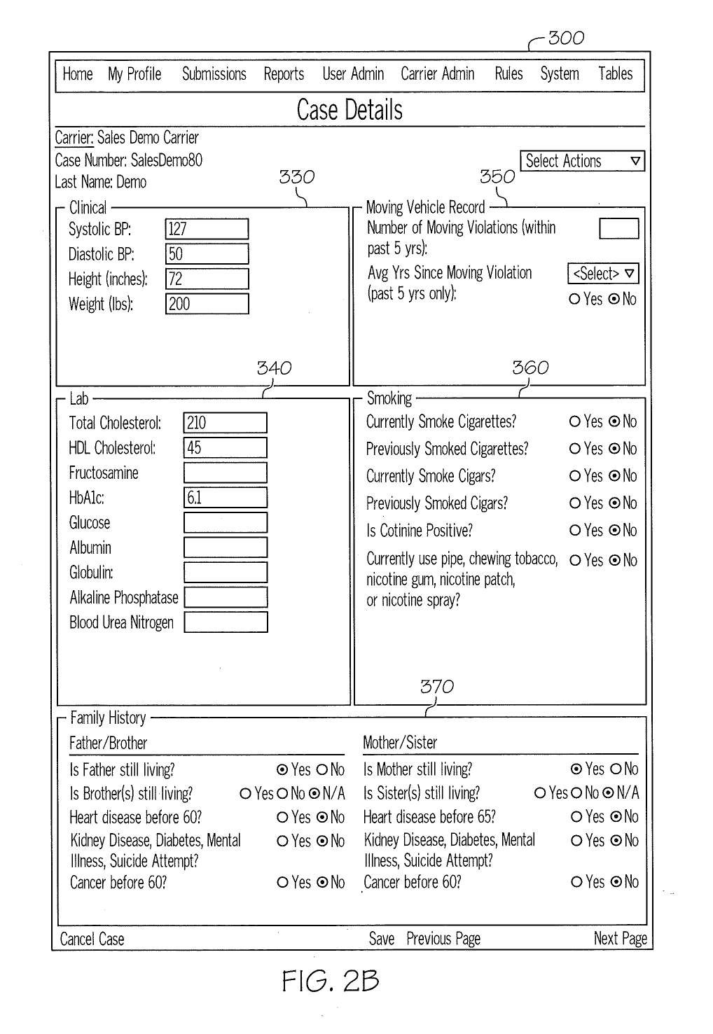

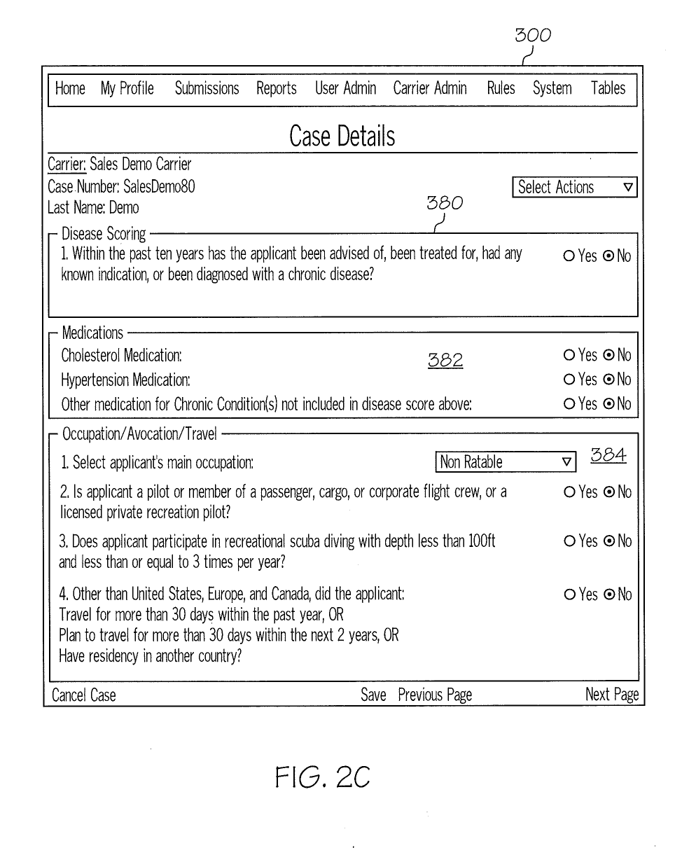

FIGS. 2A-2C illustrate an exemplary user interface 300 for obtaining information about an applicant. In some embodiments of the present invention, information is obtained about an applicant without requiring a medical examination of the applicant. For example, in FIG. 2A, the user interface 300 is configured to obtain identification information about an applicant in box 310. Exemplary identification information includes, but is not limited to insurance application case number, applicant name, applicant residency, applicant birth date, applicant sex, and the type of insurance policy being applied for.

In box 320 of user interface 300, various questions are presented to the user (which may or may not be the applicant). Exemplary questions include, but are not limited to, whether the applicant has been convicted of a felony, whether the applicant has requested or received workers compensation, social security disability, or other disability payments, whether the applicant has had military service deferment, rejection or discharge because of a physical or mental condition, whether the applicant has ever been turned down for life insurance, whether the applicant has ever used drugs, etc. In addition, user interface 300 presents various questions about aviation activities and hazardous sports.

Referring to FIG. 2B, user interface 300 is continued and includes additional boxes in which various applicant information is obtained. For example, in box 330, various clinical data is obtained, such as blood pressure, height, and weight information. In box 340, various lab data is obtained, such as cholesterol information, fructosamine information, glucose information, albumin information, etc. In box 350, applicant moving vehicle record information is obtained, such as the number of moving violations, the number of years since the last moving violation, etc. In box 360, applicant smoking information is obtained. Family history information is obtained in box 370. Embodiments of the present invention are advantageous over conventional underwriting methodologies because incomplete information may be utilized in making an underwriting decision. As such, embodiments of the present invention do not require input of all the information displayed in FIG. 2B.

Referring to FIG. 2C, user interface 300 is continued and includes additional boxes in which various applicant information is obtained. For example, in box 380, information about chronic diseases is obtained. In box, 382, information about applicant medications is obtained, and in box 384, information about applicant occupation/avocation travel is obtained.

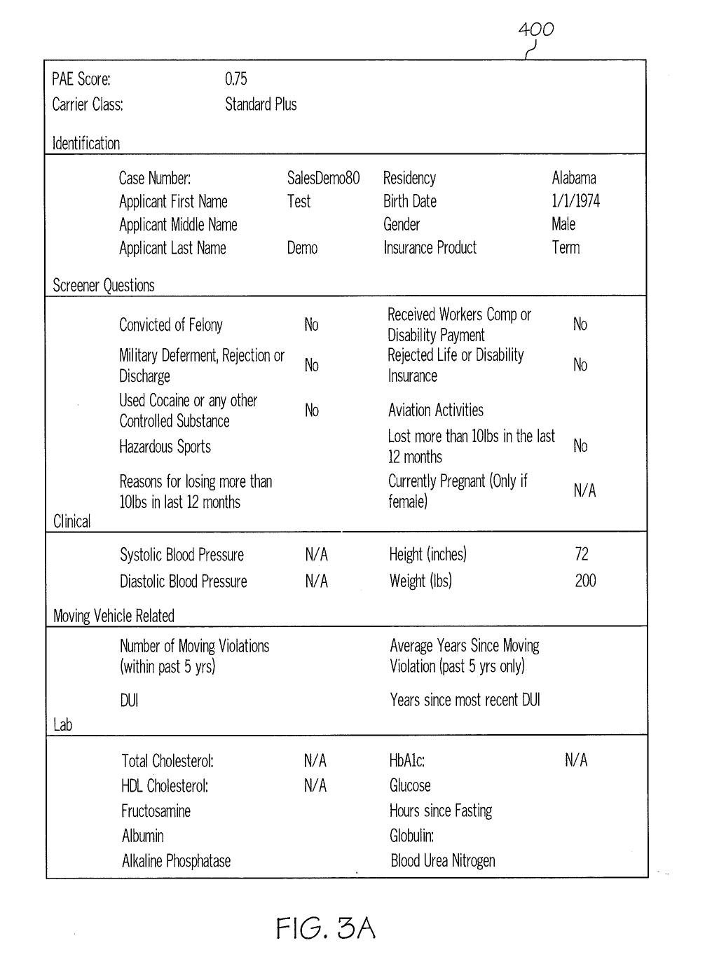

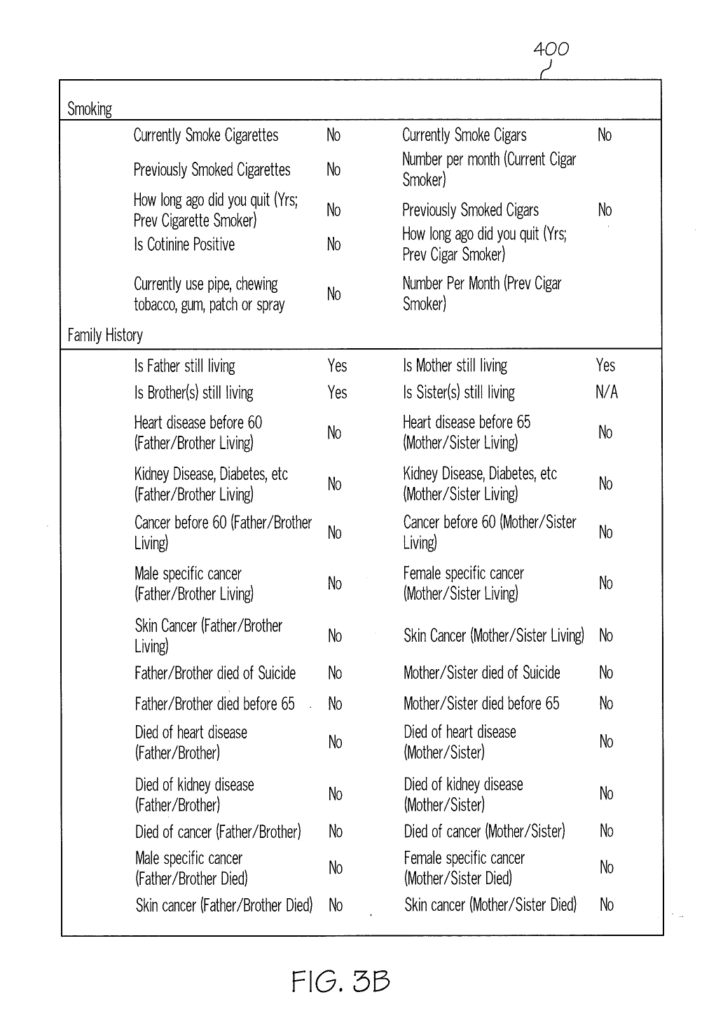

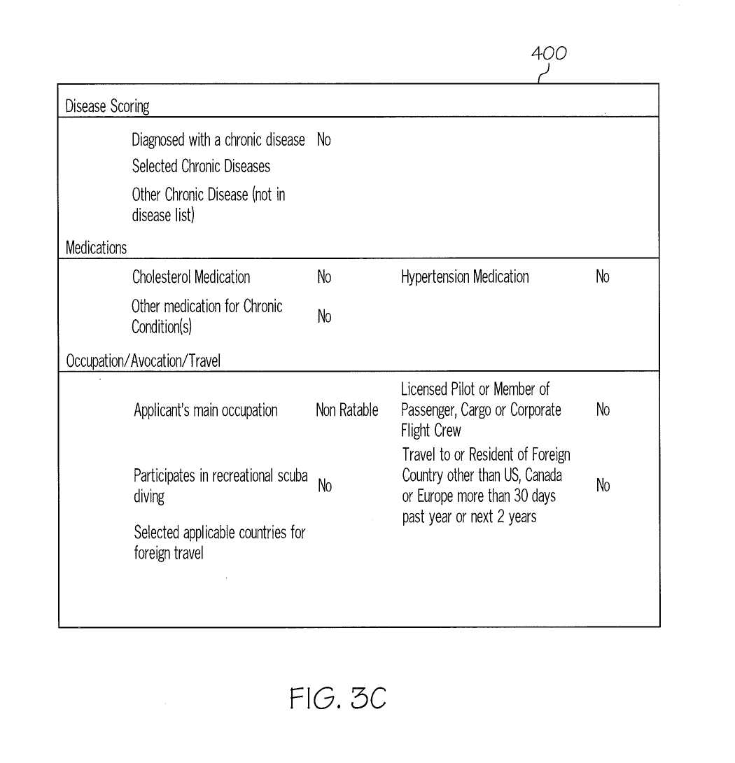

FIGS. 3A-3C illustrate an output report 400 that contains the various data elements obtained via user interfaces 2A-2C. The illustrated output report 400 is a summary of data entered into the system via the user interfaces of FIGS. 2A-2C. A PAE score is displayed at the top of the illustrated report 400. This value represents the predicted mortality of the individual applicant relative to the population mortality (i.e., 2001 VBT), as calculated in accordance with embodiments of the present invention. This score may serve multiple purposes, one of which is to classify applicants to carrier-specific risk/premium categories shown as the carrier-specific class below the PAE value at the top of the report 400 in FIG. 3A.

Embodiments of the present invention allow life insurers to choose the specific data elements that are collected for an applicant. For example, an insurer may design a life insurance product that requires only the following underwriting data: age, gender, smoking status, family history, disease history, height and weight, MVR record, MIB check, and pharmacy record. These data elements are typically required for a “simplified underwriting” product. Clinical lab tests and blood pressure measurements, which are usually required in full medical underwriting, may not be required in a standard simplified underwriting process. Typically, an insurer chooses the extent of the data collection, depending on the face amount of a life insurance policy, the applicant's age and gender, and/or features of the specific life insurance product—that is, the life insurer may elect to obtain all or part of the data elements mentioned. A user interface, such as user interface 300 of FIGS. 2A-2C, can be tailored to collect specific data according to the specific needs of an insurance company. For example, some data elements on FIG. 3A were shown as blank or N/A, which indicates the data element was not collected or otherwise unavailable.

Referring back to FIG. 1, the obtained information is checked for any data elements that are considered “outliers” i.e., a data element that falls outside a specified threshold (Block 110). When a data element reaches a specified threshold, a significant increase in mortality may be indicated and the applicant's data may require further evaluation by a trained underwriter. As such, an underwriter is notified (Block 120). If identified data elements are beyond an a priori-specified threshold, then the applicant is excluded from further assessment because he/she is regarded as ineligible (Block 130). An assessment by the underwriter is then needed. Data used to exclude an applicant may include, but are not limited to, multiple driving while impaired (DWI) records, frequent travel to a dangerous foreign country, engagement in a dangerous sport or activity (e.g., sky diving, motorcycle racing, etc.), or significant chronic disease history. In some embodiments, some data elements are used for outlier screening only, while other data elements are used for both outlier screening and risk calculation. For example, engaging in dangerous sports may be used for screening only. Disease history may be used for both screening (ineligible if several chronic diseases exist) and risk calculation (minor disease history only).

Next, a population dataset representative of the insurance population is obtained (Block 140). This population dataset contains a historical life insurance population with known values of various underwriting data elements (x₁, x₂, . . . xₙ). Using this dataset, the age-, gender-, and smoking status-specific population mean (or average) for each underwriting data element (xₙ) obtained for a particular applicant is derived and is expressed as x₁ₘ, x₂ₘ, . . . xₙₘ (for each age, gender, and smoking status).

For each applicant data element, the deviation from the applicant's age-, gender-, and smoking status-specific population mean is determined (Block 150). This is expressed as x₁−x₁ₘ; x₂−x₂ₘ; . . . xₙ−xₙₘ. For example, if a non-smoker applicant has a BMI of 27 and the mean value for BMI in the applicant's age, gender, and non-smoker population is 25, the deviation is calculated as 27−25=2.

Next, a mortality relative risk (RR) estimate is obtained for each applicant data element (Block 160). This may be obtained, for example, from either peer-reviewed clinical literature or from the method described in U.S. Pat.. No 6,110,109, to Hu et al., which is incorporated herein by reference in its entirety. The method described by Hu et al. allows for the estimation of multivariate relative risk from univariate relative risk, as is typically derived from clinical literature and meta-analysis.

Next, the mortality ratio (MR) for the applicant is determined using the deviation and RR for each applicant data element (Block 170). This is represented by the following equation:

MR=exp (ln(RR₁)(x₁−x₁ₘ)+ln(RR₂)(x₂−x₂ₘ) . . . ln(RRₙ)(xₙ−xₙₘ)).

The above equation for determining MR does not require all data elements. For example, if one or more data elements are not available, they are removed from the equation. As such, embodiments of the present invention allow an underwriting decision to be made when some applicant data is missing and/or unobtainable.

Next, the population mortality is obtained (Block 180). Population mortality may be obtained through historical-claim experience and/or actuarial projection. For example, the mortality projection for the total population is 80% of the 2001 Valuation Basic Table (VBT). The VBT is a standard mortality table stratified by age, gender, and smoking status, and was developed by the Society of Actuaries using pooled data from the life insurance industry. This 80% mortality is also expressed as an actual vs. expected ratio (A/E ratio). The expected value is obtained from the 2001 VBT, and therefore, an A/E ratio of 0.8 equates to a mortality that is 80% of the expected mortality, by age, gender, and smoking status, according to the 2001 VBT. According to some embodiments of the present invention, the population mortality may be obtained from data storage (local or remote) and/or may be obtained from one or more on-line sources.

The applicant's mortality ratio (MR) is then applied to the population mortality to generate the applicant's specific mortality risk (Block 190). This may be referred to as a predicted A/E ratio or PAE.

Under certain embodiments, the applicant is then classified to an underwriting class based on the applicant's predicted mortality risk (PAE) (Block 200) and the expected mortality of each underwriting class. Commonly, insurance companies offer multiple classes with different premium levels. For example, a life insurance company may classify applicants into preferred, standard, substandard, and declined (uninsurable) classes. Both preferred and standard classes may have smoker and non-smoker sub-classes. Applicants in the “standard” group are individuals who, according to the insurance company's underwriting standards, are entitled to term insurance without having to pay a rating surcharge or be subjected to policy restrictions.

Applicants in the “preferred risks” group are individuals whose mortality experience (i.e., life expectancy) as a group is expected to be above average and to whom the company offers a lower than standard rate.

Applicants in the “substandard risks” group are individuals who, because of their health and/or other factors, cannot be expected (on average) to live as long as people who are not subject to these risk factors. Substandard applicants are insurable, but only at higher than standard rates that reflect the added risk. Policies issued to substandard applicants are referred to as rated or extra risk policies.

Applicants in the “uninsurable” group are individuals to whom the life insurance company refuses to sell insurance because they are unwilling to shoulder the risks. The life insurance company has decided that the risk factors associated with the applicant are too great or too numerous. In other cases, the applicant's circumstances may be so rare or unique that the company has no basis to arrive at a suitable premium.

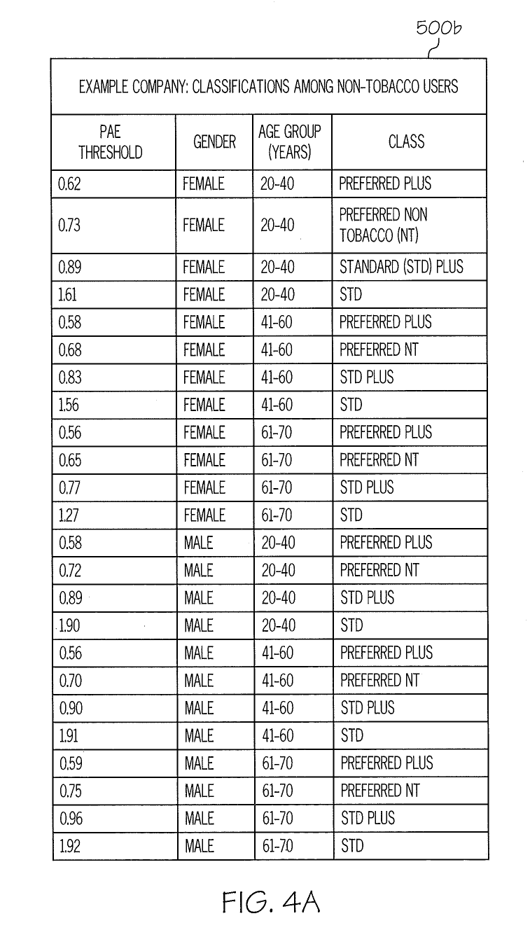

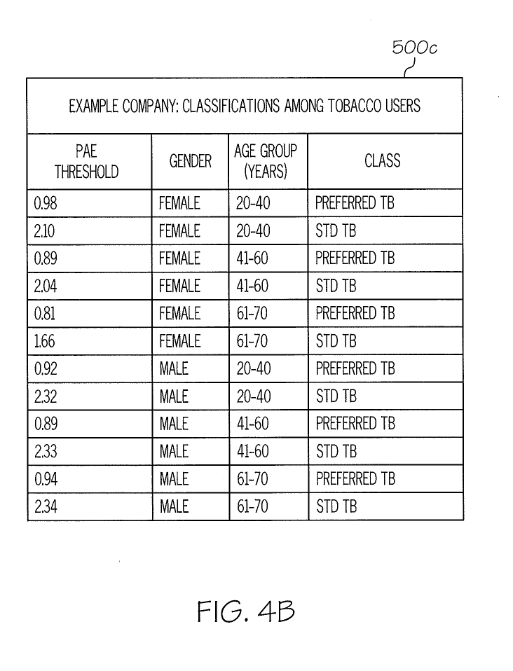

Premiums associated with each underwriting class (except declined) are based on the expected mortality of the class. This assignment is typically company specific. Therefore, in some embodiments of the present invention, the PAE thresholds may also be company specific. In theory, company-specific PAE thresholds are set so that the applicants who qualified for the given class fall within a specific PAE range, and the average PAE or the predicted mortality of the class is close to the expected mortality of the class. For example, when a company offers a super-preferred non-tobacco class, the premium of this class is set based on an expected mortality of this class as 48% of the 2001 SOA VBT table. In some embodiments of the present invention, using this information, a PAE threshold is set to 0.6, because in a typical applicant population, those with a PAE<0.6 will have an average PAE of approximately 0.48. Using this method, the predicted mortality of the entire class will match the expected mortality. FIGS. 4A-4B are examples of PAE thresholds from a non-disclosed, example company. FIG. 4A is for non-tobacco users, and FIG. 4B is for tobacco users. For optimal utility, the PAE thresholds can also be age and gender specific. As illustrated in FIG. 4A, a female applicant between the ages of 20 and 40 years who is a non-tobacco user with a PAE<0.62 will be classified as “preferred plus”, with a PAE between 0.62 and <0.73 will be classified as “preferred non tobacco”, with a PAE between 0.73 and <0.89 will be classified as “standard plus”, with a PAE between 0.89 and <1.61 will be classified as “standard”, and with a PAE >1.61 will be classified as substandard after the declined risk has been excluded.

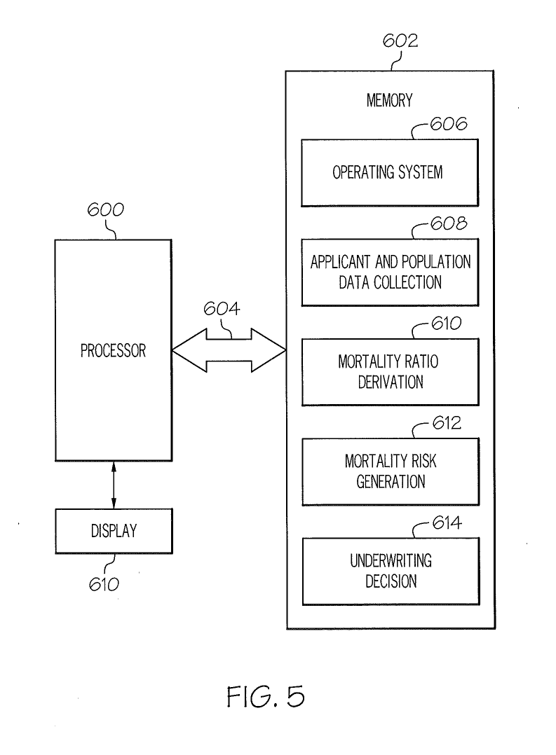

FIG. 5 illustrates an exemplary processor 600 and memory 602 that may be utilized to facilitate life insurance underwriting with incomplete data, according to some embodiments of the present invention. However, embodiments of the present invention are not limited to a single processor and memory. Multiple processors and/or memory may be utilized, as would be understood by those skilled in the art.

The processor 600 and memory 602 may be utilized to quickly determine an applicant's mortality risk such that a determination can be made whether or not to underwrite life insurance for the applicant and, if so, provide the carrier-specific classification result. The processor 600 communicates with the memory 602 via an address/data bus 604. The processor 600 may be, for example, a commercially available or custom microprocessor or similar data processing device. The memory 602 is representative of the overall hierarchy of memory devices containing the software and data used to perform the various operations described herein. The memory 602 may include, but is not limited to, the following types of devices: cache, ROM, PROM, EPROM, EEPROM, flash, SRAM, and DRAM.

As shown in FIG. 5, the memory 602 may hold various categories of software and data: an operating system 606, an applicant and population data collection module 608, a mortality ratio derivation module 610, a mortality risk generation module 612, and an underwriting decision module 614. The operating system 606 can be any operating system suitable for use with a data processing system, such as IBM®, OS/2®, AIX® or zOS® operating systems, Microsoft® Windows® operating systems, Android®, Unix or Linux™.

The applicant and population data collection module 608 comprises logic for obtaining applicant information (i.e., data elements) as well as a population dataset representative of the insurance population. For example, in some embodiments, the applicant and population data collection module 608 is configured to display the user interface 300 illustrated in FIGS. 2A-2C and obtain information entered by an applicant or by a person on behalf of the applicant. The applicant and population data collection module 608 also is configured to display an output report of applicant information, such as the output report 400 illustrated in FIGS. 3A-3C.

The mortality ratio derivation module 610 comprises logic for calculating the deviation of each underwriting data element from the applicant's age-, gender-, and smoking status-specific population mean, as described above. In addition, the mortality ratio derivation module 610 also comprises logic for determining a mortality relative risk (RR) estimate for each underwriting data element as described above.

The mortality risk generation module 612 comprises logic for calculating an applicant's individual mortality ratio (MR) using the following equation as described above:

MR=exp (ln(RR₁)(x₁−x₁ₘ)+ln(RR₂)(x₂−x₂ₘ) . . . ln(RRₙ)(xₙ−xₙₘ)).

The underwriting decision module 614 comprises logic for generating an underwriting decision based on the applicant's mortality risk. The underwriting decision module 614 may also be configured to place an applicant into an underwriting class based on the applicant's mortality risk, and based upon various rules/requirements of a particular life insurance company.

The processor 600 communicates with a display 610 and is configured to display the various user interfaces described above and illustrated in FIGS. 2A-2C, 3A-3C, and 4A-4B.

### EXAMPLE

A 40-year-old male applicant who is a non smoker, has height of 6′-0″ and a weight of 200 lbs (equivalent to body mass index (BMI) of 27), has no family history of heart disease or cancer, has no moving violations or driving under the influence (DUI) record, has a clean MIB record, and has no prescriptions associated with significant chronic diseases. These data elements are represented by x₁, x₂, x₃.

The present invention first checks for outlying data elements (Block 110, FIG. 1). In this example, no data elements exceed the a priori-specified thresholds (i.e., no outliers). A population dataset, which is representative of the target insurance population of 40-year-old male non smokers, is obtained and an average/mean value for each data element is calculated (Block 140, FIG. 1). In this example, the average BMI is 25, the average probability of having family history of heart disease is 10%, and the average probability of having minor chronic disease is 15%, and these data elements are represented by x₁ₘ, x₂ₘ, x₃ₘ.

A mortality relative risk (RR) estimate for each underwriting data element is obtained (Block 160, FIG. 1). In this example, the RR for BMI on mortality is 1.03. This value indicates that mortality increases by 3% for every one (1) unit increase in BMI. In this example, the relationship between BMI and mortality is treated as linear; however, multiple RRs may accommodate a non-linear relationship. Also, in this example, the RR for having minor chronic disease is 1.1 and the RR for family history of heart disease is 1.05.

The MR for the applicant is then determined using the above-described equation (i.e., MR=exp (ln(RR₁)(x₁−x₁ₘ)+ln(RR₂)(x₂−x₂ₘ) . . . ln(RRₙ)(xₙ−xₙₘ))) as follows:

MR=exp (ln(1.03)(27−25)+ln(1.05)(0−0.1)+ln(1.1)(0−0.15))=1.04

RR₁=RR for BMI; x₁=applicant's BMI; x₁ₘ=age-, gender-, and smoking status-specific population mean BMI. RR₂=RR for family history of heart disease; x₂=applicant's family history of heart disease; x₂ₘ=age-, gender-, and smoking status-specific average probability of having family history of heart disease. RR₃=RR for having minor chronic disease; x₃=applicant's history of minor chronic disease; x₃ₘ=age-, gender-, and smoking status-specific average probability of having minor chronic disease.

Next, the population mortality is obtained, for example, from data storage and/or one or more on-line sources (Block 180, FIG. 1). In this example, the population mortality is 80% of the 2001 VBT.

The applicant's mortality ratio is then applied to the population mortality to generate the applicant's specific mortality risk (Block 190, FIG. 1). In this example, the PAE value for the sample applicant is 1.04*0.8=0.83. If an example company's mortality expectation for the standard non-tobacco class is between 80% to 100% of the 2001 VBT, then this example applicant would be qualified for a standard class (Block 200, FIG. 1).

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the teachings and advantages of this invention. Accordingly, all such modifications are intended to be included within the scope of this invention as defined in the claims. The invention is defined by the following claims, with equivalents of the claims to be included therein.

That which is claimed:

1. A method of generating a decision to underwrite a life insurance policy for an applicant, the method comprising:
obtaining information about the applicant, wherein the information comprises a plurality of data elements, each data element associated with a characteristic of the applicant;
generating an individual mortality ratio value for the applicant using the plurality of data elements;
applying the mortality ratio value to a population mortality value to generate a mortality risk value for the applicant; and
generating an underwriting decision regarding the applicant based on the applicant's mortality risk value;
wherein at least one of obtaining information about the applicant, generating an individual mortality ratio value, applying the mortality ratio value to a population mortality value to generate a mortality risk value for the applicant, and generating an underwriting decision regarding the applicant are performed on at least one processor.

2. The method of claim 1, wherein obtaining the information from the applicant comprises obtaining the plurality of data elements via a user interface displayed on a device.

3. The method of claim 1, wherein obtaining information about the applicant comprises one or more of the following:
obtaining a history of smoking, alcohol consumption, and/or drug use of the applicant;
obtaining information about the applicant's family health history;
obtaining information about the applicant's health history;
obtaining applicant height, weight, age, and gender information;
obtaining applicant blood pressure readings and clinical laboratory results;
obtaining a motor vehicle report of the applicant;
obtaining a prescription drug history of the applicant;
obtaining a history of applicant's previous insurance applications and results;
obtaining a history of participation in hazardous activities of the applicant; and obtaining a history of the applicant's travel to certain foreign countries.

4. The method of claim 1, wherein generating the individual mortality ratio value for the applicant comprises:
generating a deviation of each data element from a respective mean value, expressed as x₁−x₁ₘ, x₂−x₂ₘ, . . . xₙ−xₙₘ;
obtaining a mortality relative risk estimate for each respective data element, expressed as RR₁, RR₂, . . . RRₙ; and
generating the individual mortality ratio value (MR) for the applicant via the following equation:
MR=exp (ln(RR₁)(x₁−x₁ₘ)+ln(RR₂)(x₂−x₂ₘ) . . . ln(RRₙ)(xₙ−xₙₘ)).

5. The method of claim 4, wherein the mean value for each data element is applicant age, gender, and smoking-status specific.

6. The method of claim 1, wherein the population mortality value is for a hypothetical person having the same age, gender, and smoking status as the applicant.

7. The method of claim 1, wherein obtaining information about the applicant comprises excluding the applicant from further assessment should any data elements have a value that is beyond a pre-determined threshold value.

8. The method of claim 1, wherein generating an underwriting decision regarding the applicant comprises assigning the applicant to an underwriting class based on the applicant's mortality risk value.

9. A system for generating a decision to underwrite a life insurance policy for an applicant, the system comprising:
a processor; and
a memory that stores instructions that, when executed by the processor, cause the processor to perform operations comprising:
obtaining information about the applicant, wherein the information comprises a plurality of data elements, each data element associated with a characteristic of the applicant;
generating an individual mortality ratio value for the applicant using the plurality of data elements;
applying the mortality ratio value to a population mortality value to generate a mortality risk value for the applicant; and
generating an underwriting decision regarding the applicant based on the applicant's mortality risk value.

10. The system of claim 9, wherein obtaining the information from the applicant comprises obtaining the plurality of data elements via a user interface displayed on a device.

11. The system of claim 9, wherein obtaining information about the applicant comprises one or more of the following:
obtaining a history of smoking, alcohol consumption, and/or drug use of the applicant;
obtaining information about applicant's family health history;
obtaining information about the applicant's health history;
obtaining applicant height, weight, age, and gender information;
obtaining applicant blood pressure readings and clinical laboratory results;
obtaining a motor vehicle report of the applicant;
obtaining a prescription drug history of the applicant;
obtaining a history of applicant's previous insurance applications and results;
obtaining a history of participation in hazardous activities of the applicant; and
obtaining a history of the applicant's travel to certain foreign countries.

12. The system of claim 9, wherein generating the individual mortality ratio value for the applicant comprises:
generating a deviation of each data element from a respective mean value, expressed as x₁−x₁ₘ, x₂−x₂ₘ, . . . xₙ−xₙₘ;
obtaining a mortality relative risk estimate for each respective data element, expressed as RR₁, RR₂, . . . RRₙ; and
generating the individual mortality ratio value (MR) for the applicant via the following equation:
MR=exp (ln(RR₁)(x₁−x₁ₘ)+ln(RR₂)(x₂−x₂ₘ) . . . ln(RRₙ)(xₙ−xₙₘ)).

13. The system of claim 12, wherein the mean value for each data element is applicant age, gender, and smoking-status specific.

14. The system of claim 9, wherein the population mortality value is for a hypothetical person having the same age, gender, and smoking status as the applicant.

15. The system of claim 9, wherein obtaining information about the applicant comprises excluding the applicant from further assessment should any data elements have a value that is beyond a pre-determined threshold value.

16. The system of claim 9, wherein generating an underwriting decision regarding the applicant comprises assigning the applicant to an underwriting class based on the applicant's mortality risk value.

17. A computer program product, comprising a non-transitory computer readable storage medium having encoded thereon instructions that, when executed by a processor, cause the processor to perform operations comprising:
obtaining information about the applicant, wherein the information comprises a plurality of data elements, each data element associated with a characteristic of the applicant;
generating an individual mortality ratio value for the applicant using the plurality of data elements;
applying the mortality ratio value to a population mortality value to generate a mortality risk value for the applicant; and
generating an underwriting decision regarding the applicant based on the applicant's mortality risk value.

18. The computer program product of claim 17, wherein obtaining the information from the applicant comprises obtaining the plurality of data elements via a user interface displayed on a device.

19. The computer program product of claim 17, wherein obtaining information about the applicant comprises one or more of the following:
obtaining a history of smoking, alcohol consumption, and/or drug use of the applicant;
obtaining information about applicant's family health history;
obtaining information about the applicant's health history;
obtaining applicant height, weight, age, and gender information;
obtaining applicant blood pressure readings and clinical laboratory results;
obtaining a motor vehicle report of the applicant;
obtaining a prescription drug history of the applicant;
obtaining a history of applicant's previous insurance applications and results;
obtaining a history of participation in hazardous activities of the applicant; and
obtaining a history of the applicant's travel to certain foreign countries.

20. The computer program product of claim 17, wherein generating the individual mortality ratio value for the applicant comprises:
generating a deviation of each data element from a respective mean value, expressed as x₁−x₁ₘ, x₂−x₂ₘ, . . . xₙ−xₙₘ;
obtaining a mortality relative risk estimate for each respective data element, expressed as RR₁, RR₂, . . . RRₙ; and
generating the individual mortality ratio value (MR) for the applicant via the following equation:
MR=exp (ln(RR₁ )(x₁−x₁ₘ)+ln(RR₂)(x₂−x₂ₘ) . . . ln(RRₙ)(xₙ−xₙₘ)).

21. The computer program product of claim 20, wherein the mean value for each data element is applicant age, gender, and smoking-status specific.

22. The computer program product of claim 17, wherein the population mortality value is for a hypothetical person having the same age, gender, and smoking status as the applicant.

23. The computer program product of claim 17, wherein obtaining information about the applicant comprises excluding the applicant from further assessment should any data elements have a value that is beyond a pre-determined threshold value.

24. The computer program product of claim 17, wherein generating an underwriting decision regarding the applicant comprises assigning the applicant to an underwriting class based on the applicant's mortality risk value.
